(19) United States
(12) Patent Application Publication
(10) Pub. No.: US 2007/0047409 A1
(43) Pub. Date: Mar. 1, 2007

(54) Data recording system and control method thereof

(76) Inventor: Liang-Yun Wang, Taipei City (TW)

Correspondence Address: THE LAW OFFICES OF ANDREW D. FORTNEY, PH.D., P.C., 401 W FALLBROOK AVE STE 204, FRESNO, CA, 93711-5835, US

(21) Appl. No.: 11/515,178

(22) Filed: Aug. 31, 2006

Related U.S. Application Data
(60) Provisional application No. 60/712,801, filed on Aug. 31, 2005.

(51) Int. Cl. G11B 7/12

(52) U.S. Cl. 369/47.53

(57) ABSTRACT

A data recording control method for an optical recording system is provided. The optical recording system includes a host and an optical recording device. The method first provides a set of preferences about a write strategy learning at the host. Then, at the optical recording device, the method performs the write strategy learning, according to the set of preferences, to generate an updated write strategy for recording data on an optical storage medium.

### BACKGROUND OF THE INVENTION

1. Field of the Invention

The present invention relates to a data recording control method, and more particularly, to an optical recording system and control method thereof.

2. Description of the Prior Art

Writable and re-writable storage optical media for storing information, such as CD and DVD disks, are more and more popular. Due to different materials and manufacturing procedures, each type of storage optical media may require a specific write strategy. Generally, an optical drive has a write strategy table embedded in its firmware, which records lots of write strategies corresponding to different types of storage optical media. Before recording information to an optical storage medium, the optical drive will retrieve an identification code recorded on the optical storage medium and select a proper write strategy according to the identification code from the write strategy table.

However, there are always many new types storage optical media not recorded in the write strategy table in time. In order to prevent faults and errors induced by adopting an improper write strategy, most optical drives have learning mechanisms which are started when a proper write strategy is not found in the write strategy table. The learning mechanisms can be categorized into three kinds as respectively illustrated in FIG. 1A through FIG. 1C.

Please refer to FIG. 1A. The first learning mechanism generates a write strategy along with power settings during an optimum power control (OPC) period in step S101. In the first learning mechanism, test data is burned on the most inner or most outer rims of a disk. After the OPC period, optical drives perform the learnt write strategy to record actual user data on the optical storage medium in step S102. The disadvantage of the first learning mechanism is that the time of an OPC period is longer so that an actual write operation is delayed. Besides, test areas in the first learning mechanism are worse than the other areas on the disk so that the test results are usually inaccurate.

FIG. 1B illustrates the flowchart of the second learning mechanism. Power settings are first generated during an OPC period in step S103. In this learning mechanism, a preset write strategy is provided. In step S104, the preset write strategy is performed to record information on an optical storage medium and measurements on recorded information are simultaneously taken. In step S105, an adjusted write strategy is generated based on the measured results. In step S106, the adjusted write strategy is performed to record information on the optical storage medium and measurements on recorded information are simultaneously taken. To optimize the adjusted write strategy, step S105 and step S106 are continuously repeated. That is to say, the second learning mechanism enables an optical drive to adjust its write strategy on the fly during the whole writing process. However, the second learning mechanism does not perform well unless the continuous tuning method is stable and never destroys user data by accident, which is difficult to guarantee.

FIG. 1C illustrates the flowchart of the third learning mechanism. As shown in FIG. 1C, step S107 is the same as step S103. In this learning mechanism, a preset write strategy is also provided. In step S108, a preset write strategy is performed to record information on an optical storage medium. The third learning mechanism enables an optical drive to pause, seek back, and measure the write quality of some areas which are just burned in step S109. Then, the third learning mechanism analyzes the measured results. The optical drive adjusts the preset write strategy based on the measured results in step S110 and subsequently performs the adjusted write strategy to record information on the optical storage medium in step S111. To optimize the adjusted write strategy, step S1109 through step S111 are continuously repeated. Because of the time taken by step S109, the third learning mechanism also delays the actual write operation as the first learning mechanism. Furthermore, the quality of link points where the optical drive pauses and re-starts would be worse than the other areas on the disk.

In prior arts adopting the learning mechanisms described above, users can only decide whether to enable a learning mechanism or not. On which areas the learning mechanism is performed, when the learning mechanism is performed, and how much time the learning mechanism will take all cannot be previously known by users.

### SUMMARY OF TH INVENTION

To improve the aforementioned learning mechanisms and to offer users more options, this invention provides an optical disc recording system and a data recording control method thereof. The system includes a host and an optical recording device, and this invention establishes better cooperation between the host and the optical recording device. According to this invention, users can decide where and when a learning mechanism is performed and can set time limits for the learning mechanism.

One aspect of this invention is a data recording control method for an optical disc recording system, which includes a host and an optical recording device. This method first provides a set of preferences about a write strategy learning at the host. Then, at the optical recording device, the method performs the write strategy learning, according to the set of preferences, to generate an updated write strategy for recording data on an optical storage medium.

Another aspect of this invention is an optical recording system. The system includes a host and an optical recording device. The optical recording device is coupled to the host. The host is used for providing a set of preferences about a write strategy learning. According to the set of preferences provided by the host, the optical recording device performs the write strategy learning to generate an updated write strategy for recording data on an optical storage medium.

The advantage and spirit of the invention may be understood by the following recitations together with the appended drawings.

### BRIEF DESCRIPTION OF THE APPENDED DRAWINGS

FIG. 1A illustrates the flowchart of the first learning mechanism; FIG. 1B illustrates the flowchart of the second learning mechanism; FIG. 1C illustrates the flowchart of the third learning mechanism.

FIG. 2 illustrates an optical recording system according to this invention.

FIG. 3 illustrates an example in which the control method according to the present invention is applied.

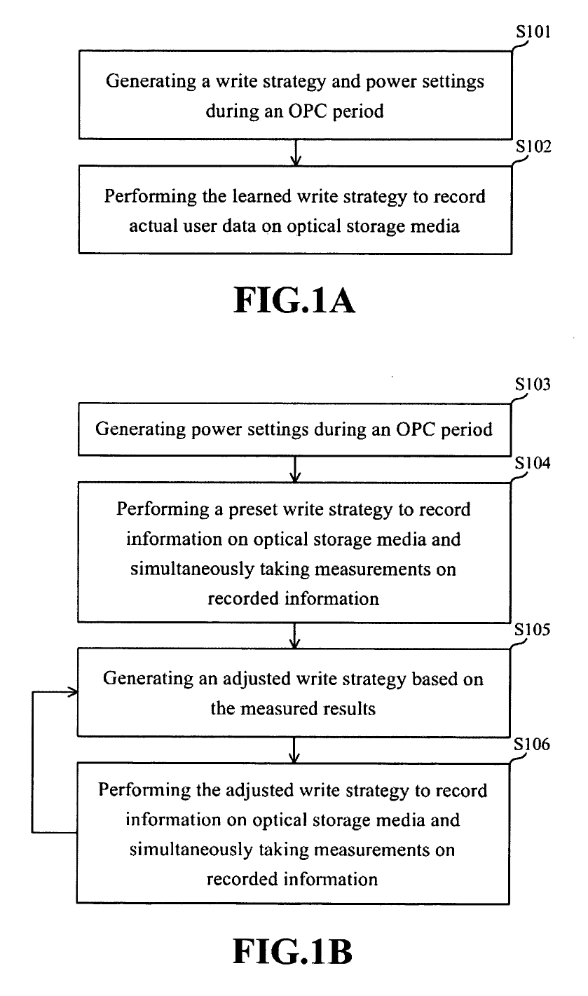

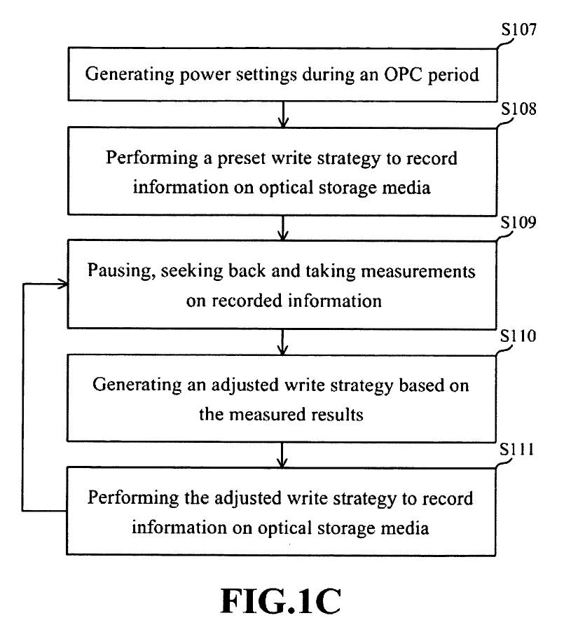

### DETAILED DESCRIPTION OF THE INVENTION

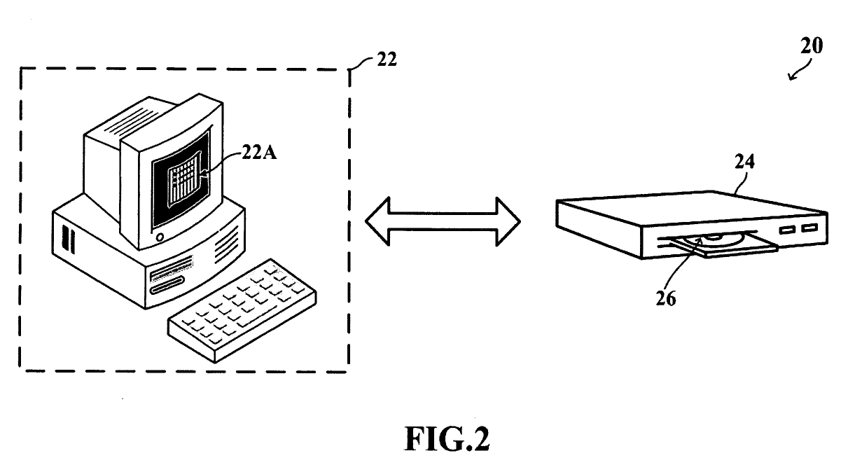

This invention provides an optical recording system and a data recording control method thereof. As shown in FIG. 2, an optical recording system 20 according to this invention includes a host 22 and an optical recording device 24. The host 22 may be a personal computer or other electrical apparatuses that can support the operation of the optical recording device 24. The optical recording device 24 has a laser operable to read information from or write information to an optical storage medium 26, such as a CD-R, CD-RW, DVD-R, DVD-RW, or DVD-RAM disk.

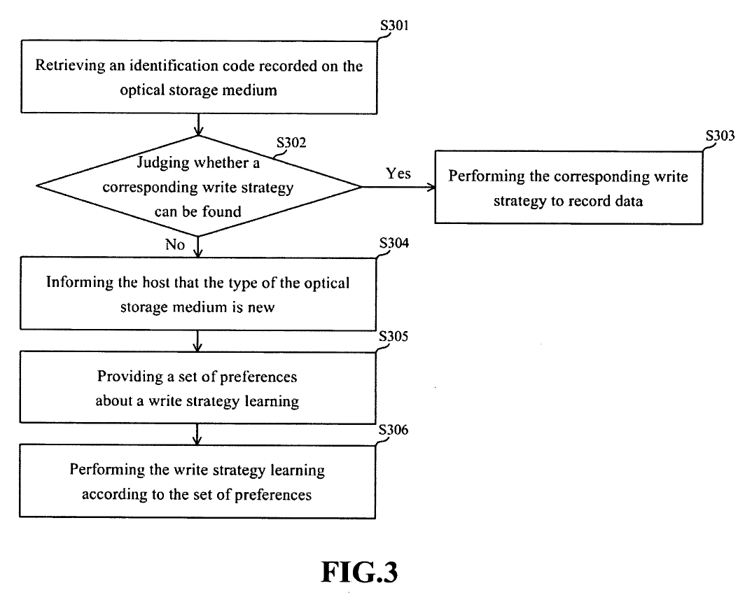

Please refer to FIG. 3. FIG. 3 illustrates an example in which the control method according to the present invention is applied. In step S301, the optical recording device 24 is operated to retrieve an identification code recorded on the optical storage medium 26. The identification code generally includes a manufacturer number and a type number. In step S302, it is judged that whether a write strategy corresponding to the identification code can be found in a write strategy table of the optical recording device 24. If the judging result of step S302 is YES, a corresponding write strategy is then performed to record data on the optical storage medium 26 in step S303. If the judging result of step S302 is NO, step S304 is then performed. In step S304, the optical recording device 24 informs the host 22, may be through an ATAPI interface, that the type of the optical storage medium 26 is new to the optical recording device 24. Subsequently, the host 22 provides a set of preferences about a write strategy learning to the optical recording device 24 in step S305. In step S306, the optical recording device 24 performs the write strategy learning, according to the set of preferences, to generate an updated write strategy for recording data on the optical storage medium 26.

In actual applications, the set of preferences may be established based on previous using habits of users of the optical recording system 20 and be previously stored in the host 22. Alternatively, between steps S304 and S305, the host 22 can provide a user interface 22A at the host 22 for querying a user to select the set of preferences. The host 22 can also fetch a plurality of default preferences from the optical recording device 24 and prompt the user to choose the set of preferences from the plurality of default preferences.

With the set of preferences, users can decide where and when a learning mechanism is performed and can set time limits for the learning mechanism. For instance, the set of preferences can include a set of timing preferences. The set of timing preferences is relative to timings for the optical recording device 24 to start, pause, or stop the write strategy learning. The limits can be set by ATAPI commands. Through controlling the timings, total time limits for the first and second learning mechanisms described in the related art can be set. Similarly, a single interruption time in the third learning mechanism described in the related art can be set users, too.

The set of preferences can include a set of area preferences as well. The set of area preferences is relative to which area on the optical storage medium 26 is used for the write strategy learning. For every speed setting in the write strategy learning, different test areas can be selected. The optical recording device 24 is generally operated to compile a file system on the optical storage medium 26 to record which areas on the optical storage medium 26 are used for the write strategy learning. In actual application, the optical recording device 24 can provide a linking loss area for every point on the optical storage medium 26 where the optical recording device 24 is commanded to pause. In the file system, the linking loss area can also be recorded. With the information recorded in the file system, test areas can be skipped when actual user data is read from the optical storage medium 26.

The optical storage medium 26 generally has a plurality of sections. In the set of area preferences, users can decide how many areas (i.e. sections) are used for the write strategy learning. As known by those skilled in this art, the more sections are used for learning, the more accurate the learning results are. On the contrary, the more sections are used for learning, the fewer sections can be used for recording actual user data since the number of sections on the optical storage medium 26 is fixed. Thus, the method according to this invention also offers users the opportunity to decide how many sections are going to be used for the write strategy learning.

Furthermore, the set of preferences can include a start preference. The start preference is relative to whether the write strategy learning is going to be started or not. If the write strategy learning is not going to be started, a predetermined write strategy provided by the optical recording device 24 may be adopted to record data on the optical storage medium 26.

In actual applications, the host 22 can command the optical recording device 24 to take a test write on the optical storage medium 26 and to take a quality measurement of the test write. On the other hand, when the updated write strategy is performed by the optical recording device 24, the host 22 can command the optical recording device 24 to pause and to take a quality measurement for the optical storage medium 26. Based on the results of the quality measurement, the updated write strategy can be further adjusted. If the user is satisfied with the results of the quality measurement, the updated write strategy can be stored in the optical recording device 24 or uploaded to the host 22 for further use. Thus, if the same type of optical storage medium is used next time, the learning mechanism does not have to be performed again.

After the write strategy learning is performed, the host 22 can command the optical recording device 24 to report a readability index for a given range of the optical storage medium 26. The readability index may include jitter, PI/PO error counts, S/N ratios and other error counters. The readability index may be average for the entire recording or area based the LBA range it covers. Similarly, the host 22 can command the optical recording device 24 to report a capacity loss due to the write strategy learning.

With the example and explanations described above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A data recording control method for an optical recording system, said system comprising a host and an optical recording device, the method comprising:
at the host, providing a set of preferences about a write strategy learning; and
at the optical recording device, performing the write strategy learning, according to the set of preferences, to generate an updated write strategy for recording data on an optical storage medium.

2. The method of claim 1, wherein the set of preferences is previously stored in the host.

3. The method of claim 1, further comprising:
providing a user interface at the host for querying a user to select the set of preferences.

4. The method of claim 3, further comprising:
fetching a plurality of default preferences from the optical recording device and prompting the user to choose the set of preferences from the plurality of default preferences.

5. The method of claim 1, wherein the set of preferences comprises a set of timing preferences; the set of timing preferences is relative to timings for the optical recording device to start, pause, or stop the write strategy learning.

6. The method of claim 1, wherein the set of preferences comprises a set of area preferences; the set of area preferences is relative to which area on the optical storage medium is used for the write strategy learning.

7. The method of claim 1, wherein the set of preferences comprises a start preference; the start preference is relative to whether the write strategy learning is going to be started or not.

8. The method of claim 1, further comprising:
commanding the optical recording device to take a test write on the optical storage medium and to take a quality measurement of the test write.

9. The method of claim 1, further comprising:
compiling a file system on the optical storage medium to record which area on the optical storage medium is used for the write strategy learning.

10. The method of claim 1, further comprising:
when the updated write strategy is performed by the optical recording device, commanding the optical recording device to pause and to take a quality measurement for the optical storage medium; and
adjusting the updated write strategy based on the quality measurement.

11. The method of claim 10, further comprising:
providing a linking loss area for every point on the optical storage medium where the optical recording device is commanded to pause; and
compiling a file system to record the linking loss area.

12. The method of claim 1, further comprising:
commanding the optical recording device to report a readability index for a given range of the optical storage medium.

13. The method of claim 1, further comprising:
storing the updated write strategy in the optical recording device or
uploading the updated write strategy to the host.

14. The method of claim 1, further comprising:
reporting a capacity loss due to the write strategy learning.

15. A data recording control method for an optical recording system, said system comprising a host and an optical recording device, the method being executed between the host and the optical recording device, the method comprising:
at the host, deciding whether to perform a write strategy learning at the optical recording device or not; and
if the write strategy learning is decided to be performed performing the write strategy learning at the optical recording device to generate an updated write strategy for recording data.

16. An optical recording system comprising:
a host for providing a set of preferences about a write strategy learning; and
an optical recording device coupled to the host, according to the set of preferences provided by the host, the optical recording device performing the write strategy learning to generate an updated write strategy for recording data on an optical storage medium.

17. The system of claim 16, wherein the set of preferences is previously stored in the host.

18. The system of claim 16, wherein the host provides a user interface at the host for querying a user to select the set of preferences.

19. The system of claim 18, wherein the host fetches a plurality of default preferences from the optical recording device and prompts the user to choose the set of preferences from the plurality of default preferences.

20. The system of claim 16, wherein the set of preferences comprises a set of timing preferences; the set of timing preferences is relative to timings for the optical recording device to start, pause, or stop the write strategy learning.

21. The system of claim 16, wherein the set of preferences comprises a set of area preferences; the set of area preferences is relative to which area on the optical storage medium is used for the write strategy learning.

22. The system of claim 16, wherein the set of preferences comprises a start preference; the start preference is relative to whether the write strategy learning is going to be started or not.

23. The system of claim 16, wherein the host commands the optical recording device to take a test write on the optical storage medium and to take a quality measurement of the test write.

24. The system of claim 16, wherein the host compiles a file system on the optical storage medium to record which area on the optical storage medium is used for the write strategy learning.

25. The system of claim 16, wherein when the updated write strategy is performed by the optical recording device, the host commands the optical recording device to pause and to take a quality measurement for the optical storage medium; after the optical recording device is paused, the host adjusts the updated write strategy based on the quality measurement.

26. The system of claim 25, wherein the host provides a linking loss area for every point on the optical storage medium where the optical recording device is commanded to pause and compiles a file system to record the linking loss area.

27. The system of claim 16, wherein the host commands the optical recording device to report a readability index for a given range of the optical storage medium.

28. The system of claim 16, wherein the host stores the updated write strategy in the optical recording device or uploads the updated write strategy to the host.

29. The system of claim 16, wherein the host reports a capacity loss due to the write strategy learning.
